(19) United States
(12) Patent Application Publication
(10) Pub. No.: US 2022/0324279 A1
(43) Pub. Date: Oct. 13, 2022

(54) Vehicle Flotation Assembly

(71) Applicant: Kevin Politte, Houston, TX (US)

(72) Inventor: Kevin Politte, Houston, TX (US)

(21) Appl. No.: 17/225,446

(22) Filed: Apr. 8, 2021

(51) Int. Cl. B60F 3/00; B60R 21/01; B63B 43/14

(52) U.S. Cl. CPC B60F 3/0038; B60R 21/01; B63B 43/14; B60R 2021/0016

(57) ABSTRACT

A vehicle flotation assembly includes a plurality of bladders that is each coupled to a bottom side of a vehicle. Each of the bladders is inflatable to float the vehicle when the vehicle is exposed to flood waters. A water senor is coupled to the vehicle to sense flood waters rising beneath the vehicle. A pump is coupled to the vehicle and the pump inflates each of the bladders when the pump is turned on, and the pump is turned on when the water sensor senses flood waters. A plurality of anchor actuators is each of the anchor actuators is coupled to the bottom side of the vehicle. A plurality of anchors is each lowered from the respective anchor actuator when the respective anchor actuator is actuated into a lowering condition thereby inhibiting the vehicle from being floated away by the flood waters.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to flotation devices and more particularly pertains to a new flotation device for floating a vehicle on flood waters to inhibit the vehicle from being damaged. The device includes a plurality of bladders, a pump for inflating the bladders and a plurality of anchors. The bladders are inflated to float the vehicle and the anchors are lowered to inhibit the vehicle from floating away.

### (2) Description of Related Art Including Information Disclosed Under 37 CFR 1.97 and 1.98

The prior art relates to flotation devices including a variety of floatation devices that include inflatable bladders mounted to a vehicle for floating the vehicle in flood waters. In several instances the vehicle is anchored to a stationary object to inhibit the vehicle from floating away on the flood waters. In no instance does the prior art disclose a floatation device that includes inflatable bladders mounted to a vehicle and deployable anchors mounted to the vehicle.

### BRIEF SUMMARY OF THE INVENTION

An embodiment of the disclosure meets the needs presented above by generally comprising a plurality of bladders that is each coupled to a bottom side of a vehicle. Each of the bladders is inflatable to float the vehicle when the vehicle is exposed to flood waters. A water senor is coupled to the vehicle to sense flood waters rising beneath the vehicle. A pump is coupled to the vehicle and the pump inflates each of the bladders when the pump is turned on, and the pump is turned on when the water sensor senses flood waters. A plurality of anchor actuators is each of the anchor actuators is coupled to the bottom side of the vehicle. A plurality of anchors is each lowered from the respective anchor actuator when the respective anchor actuator is actuated into a lowering condition thereby inhibiting the vehicle from being floated away by the flood waters.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a phantom perspective view of a vehicle flotation assembly according to an embodiment of the disclosure.

FIG. 2 is a perspective in-use view of an embodiment of the disclosure.

FIG. 3 is a bottom view of an embodiment of the disclosure.

FIG. 4 is a perspective view of an embodiment of the disclosure showing bladders being inflated and anchors being lowered.

FIG. 5 is a schematic view of an embodiment of the disclosure.

### DETAILED DESCRIPTION OF THE INVENTION

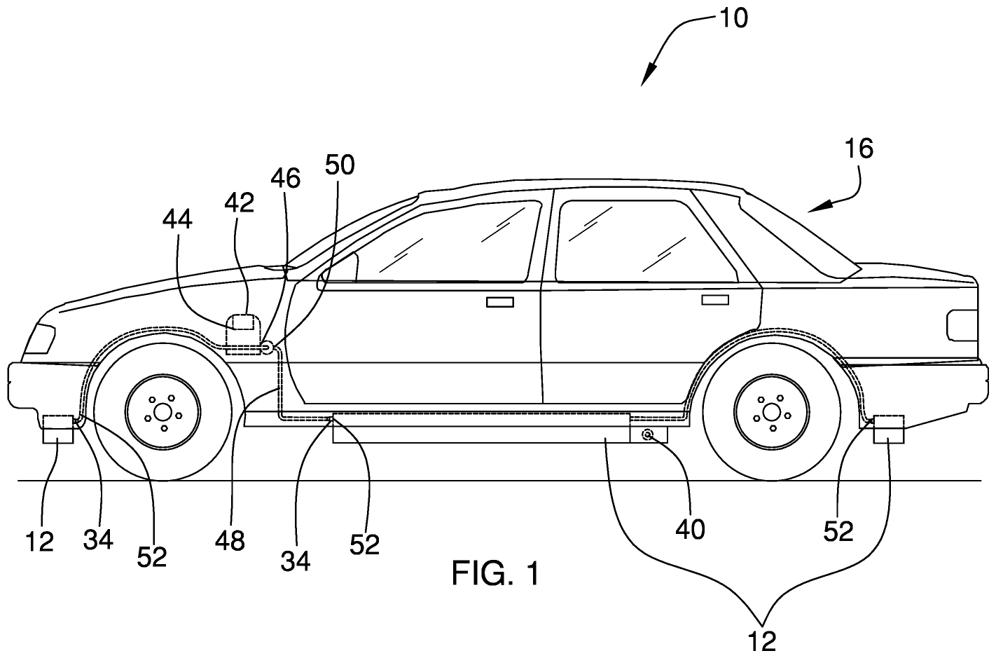

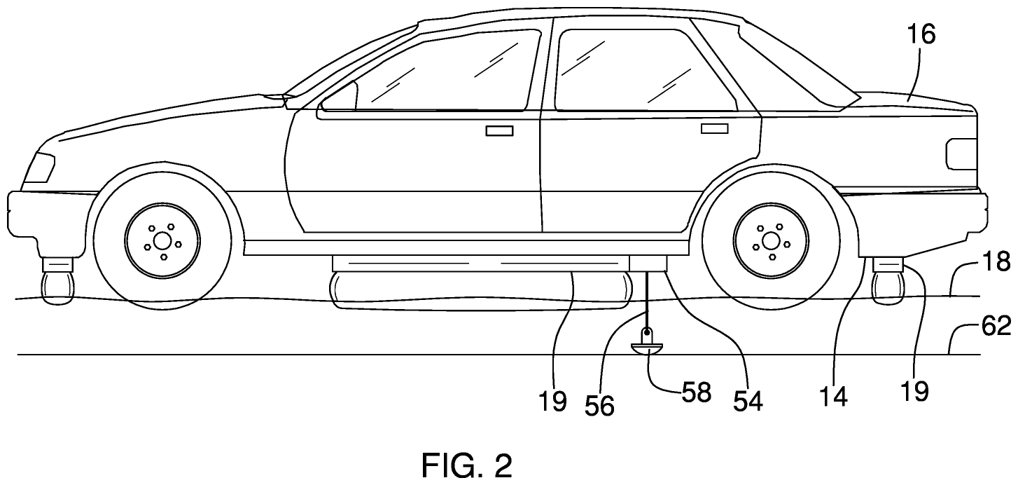

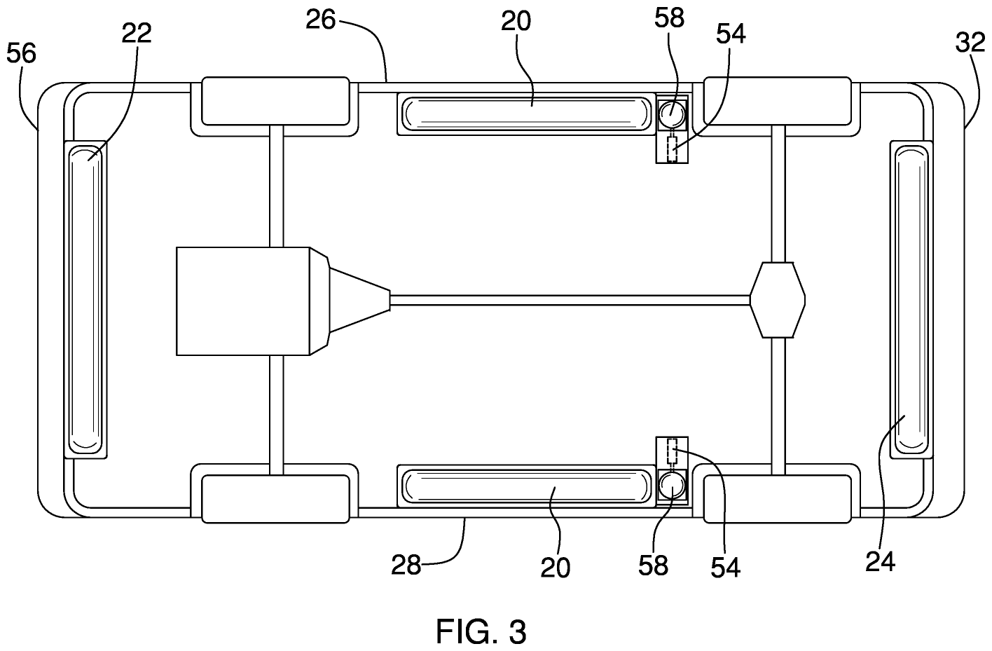

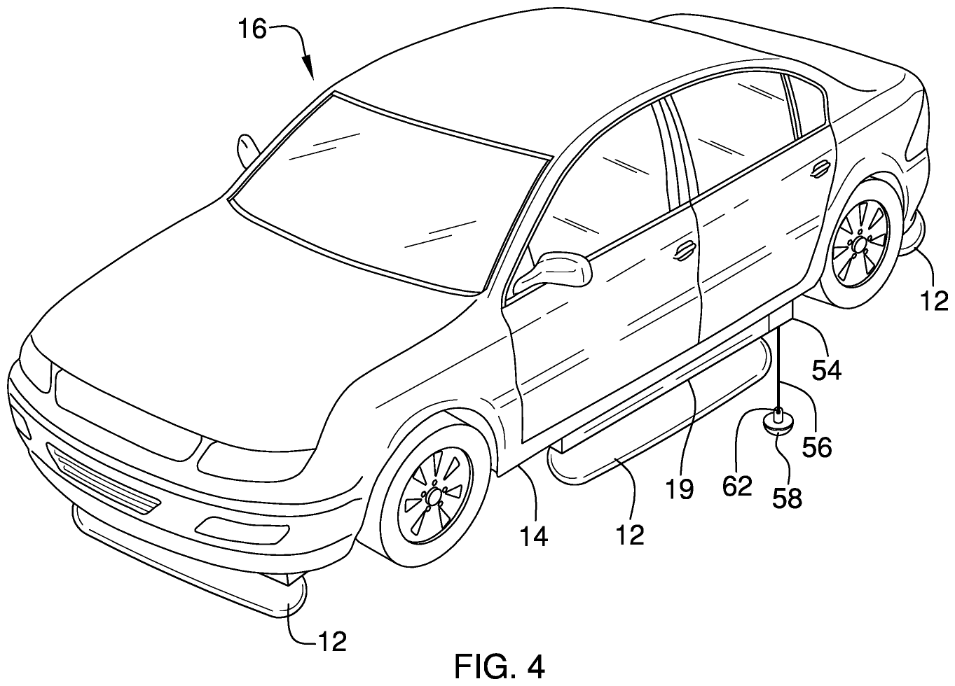

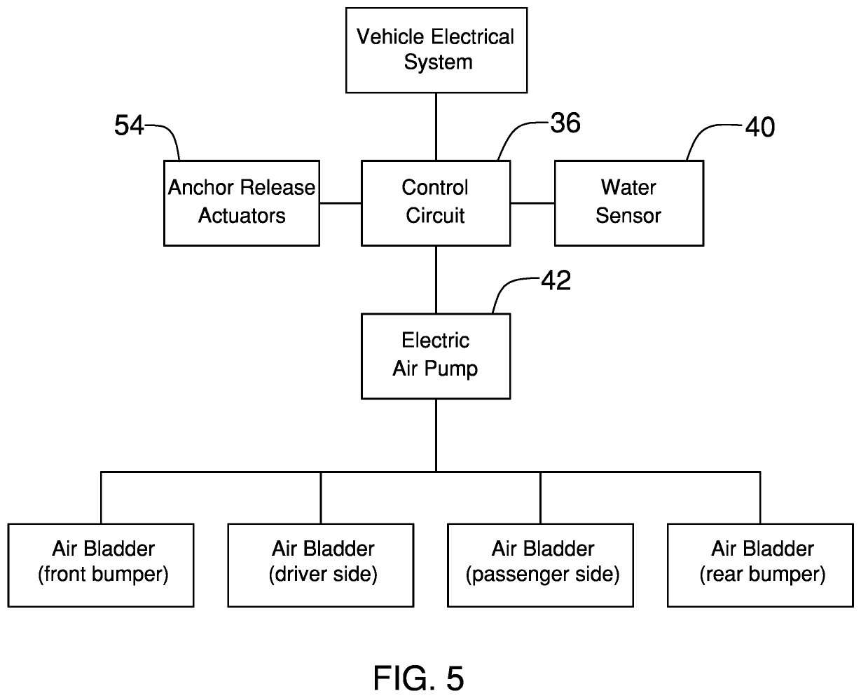

With reference now to the drawings, and in particular to FIGS. 1 through 5 thereof, a new flotation device embodying the principles and concepts of an embodiment of the disclosure and generally designated by the reference numeral 10 will be described.

As best illustrated in FIGS. 1 through 5, the vehicle flotation assembly 10 generally comprises a plurality of bladders 12 that is each coupled to a bottom side 14 of a vehicle 16. The vehicle 16 may be a passenger vehicle, a cargo vehicle or any other type of motorized vehicle that can be driven on public roadways. Each of the bladders 12 is inflatable to float the vehicle 16 when the vehicle 16 is exposed to flood waters 18. In this way the bladders 12 inhibit the vehicle 16 from being damaged by the flood waters 18. Each of the bladders 12 is distributed around a perimeter of the vehicle 16 to float the vehicle 16 on a level plane. In this way the bladders 12 inhibit the vehicle 16 from tipping in the flood waters 18. The bladders 12 may comprised of a puncture resistant material to enhance the durability and service life of the bladders 12. Each of the bladders 12 may be stored in a housing 19 or other type of containment when the bladders 12 are deflated.

The plurality of bladders 12 includes a pair of side bladders 20, a front bladder 22 and a back bladder 24. Each of the side bladders 20 is positioned adjacent to a respective one of a first lateral side 26 and a second lateral side 28 of the vehicle 16. The front bladder 22 is aligned with a front side 30 of the vehicle 16 and the back bladder 24 is aligned with a back side 32 of the vehicle 16. Each of the bladders 12 has an inflation port 34 integrated therein for inflating the bladders 12. A control circuit 36 is integrated into the vehicle 16 and the control circuit 36 is electrically coupled to a power source 38 comprising an electrical system of the vehicle 16. Additionally, the control circuit 36 receives an inflate input and a deflate input.

A water sensor 40 is coupled to the vehicle 16 and the water sensor 40 is strategically positioned on the vehicle 16 to sense flood waters 18 rising beneath the vehicle 16. The water sensor 40 may be positioned on the bottom side 14 of the vehicle 16. The water sensor 40 is electrically coupled to the control circuit 36 and the control circuit 36 receives the inflate input when the water sensor 40 senses flood waters 18. Conversely, the control circuit 36 receives the deflate input when the water sensor 40 ceases to sense the flood waters 18 subsequent to the water sensor 40 sensing the flood waters 18. The water sensor 40 may comprise an electronic water sensor that produces the inflate input when the water sensor 40 is submerged in water for a pre-determined duration of time.

A pump 42 is coupled to the vehicle 16, the pump 42 is in fluid communication with each of the bladders 12 and the pump 42 inflates each of the bladders 12 when the pump 42 is turned on. The pump 42 has an intake 44 and an exhaust 46, and the pump 42 urges air inwardly through the intake 44 and outwardly through the exhaust 46 when the pump 42 is actuated into an inflating condition. Conversely, the pump 42 facilitates air to move outwardly through the intake 44 when the pump 42 is actuated into a deflating condition. The pump 42 is electrically coupled to the control circuit 36, and the pump 42 may comprise an electric air pump or the like.

The pump 42 is actuated into the inflating condition when the control circuit 36 receives the inflate input. In this way the pump 42 facilitates the vehicle 16 to be floated on the flood waters 18. Additionally, the pump 42 is actuated into the inflating condition for a pre-determined duration of time when the control circuit 36 receives the inflate input such that the pump 42 inflates each of the bladders 12 to a sufficient volume to float the vehicle 16. The pump 42 is actuated into the deflating condition when the control circuit 36 receives the deflate input to deflate the bladders 12 when the flood waters 18 have subsided. An air manifold 48 is provided that has an inlet 50 and a plurality of outlets 52 that is each in fluid communication with the inlet 50. The inlet 50 is fluidly coupled to the exhaust 46 of the pump 42 and each of the outlets 52 is fluidly coupled to the inflation port 34 on a respective one of the bladders 12. In this way the air manifold 48 directs air between the pump 42 and each of the bladders 12 for inflating or deflating the bladders 12.

A plurality of anchor actuators 54 is provided and each of the anchor actuators 54 is coupled to the bottom side 14 of the vehicle 16. Each of the anchor actuators 54 is electrically coupled to the control circuit 36 and each of the anchor actuators 54 is actuated into a lowering condition when the control circuit 36 receives the inflate input. Conversely, each of the anchor actuators 54 is actuated into a lifting condition when the control circuit 36 receives the deflate input. Each of the anchor actuators 54 is aligned with a respective one of the first lateral side 26 and the second lateral side 28 of the vehicle 16. Each of the anchor actuators 54 may include an electric motor and a spool that is rotated by the electric motor or other type of electro-mechanical device.

A plurality of cables 56 is provided and each of the cables 56 is in mechanical communication with a respective one of the anchor actuators 54. Each of the cables 56 is lowered downwardly out of the respective anchor actuator 54 when the respective anchor actuator 54 is actuated into the lowering condition. Conversely, each of the cables 56 is drawn upwardly into the respective anchor actuator 54 when the respective anchor actuator 54 is actuated into the lifting condition. Each of the cables 56 may comprise a steel cable, a rope or other type of flexible cable that has a weight capacity of at least 20.0 pounds.

A plurality of anchors 58 is provided and each of the anchors 58 is disposed on a respective one of the anchor actuators 54. Each of the anchors 58 is lowered from the respective anchor actuator 54 when the respective anchor actuator 54 is actuated into the lowering condition. In this way each of the anchors 58 can engage a support surface 60 thereby inhibiting the vehicle 16 from being floated away by the flood waters 18. Each of the anchors 58 is lifted into the respective anchor actuator 54 when the respective anchor actuator 54 is actuated into the lifting condition. Each of the anchors 58 is coupled to a distal end 62 of a respective one of the cables 56, and each of the anchors 58 is comprised of a material that has sufficient density to facilitate each of the anchors 58 to have a weight of at least 10.0 pounds.

In use, the pump 42 is actuated into the inflating condition when the water sensor 40 senses the flood waters 18. Each of the bladders 12 is inflated and each of the anchors 58 is lowered to the support surface 60. In this way the bladders 12 facilitate the vehicle 16 to float on the flood waters 18 to inhibit the vehicle 16 from being damaged by the flood waters 18. Additionally, the anchors 58 inhibit the vehicle 16 from being floated away by the flood waters 18. In this way the vehicle 16 remains stationary until the flood waters 18 have subsided. Each of the bladders 12 is deflated and the anchors 58 are raised when the water sensor 40 no longer senses the flood waters 18. Thus, the vehicle 16 can be driven normally once the flood waters 18 have subsided.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle flotation assembly for floating a vehicle in flood waters for inhibiting the vehicle from being damaged, said assembly comprising:
a plurality of bladders, each of said bladders being coupled to a bottom side of a vehicle, each of said bladders being inflatable wherein said plurality of bladders is configured to float the vehicle when the vehicle is exposed to flood waters thereby inhibiting the vehicle from being damaged by the flood waters, each of said bladders being distributed around a perimeter of the vehicle wherein said plurality of bladders is configured to float the vehicle on a level plane thereby inhibiting the vehicle from tipping in the flood waters;
a water senor being coupled to the vehicle, said water sensor being strategically positioned on the vehicle wherein said water sensor is configured to sense flood waters rising beneath the vehicle;
a pump being coupled to the vehicle, said pump being in fluid communication with each of said bladders wherein said pump is configured to inflate each of said bladders when said pump is turned on, said pump having in intake and an exhaust wherein said pump is configured to urge inwardly through said intake and outwardly through said exhaust when said pump is actuated into an inflating condition, said pump facilitating air to move outwardly through said intake when said pump is actuated into a deflating condition, said pump being in communication with said water sensor, said pump being turned on when said water sensor senses flood waters;
a plurality of anchor actuators, each of said anchor actuators being coupled to the bottom side of the vehicle; and
a plurality of anchors, each of said anchors being disposed on a respective one of said anchor actuators, each of said anchors being lowered from said respective anchor actuator when said respective anchor actuator is actuated into a lowering condition wherein each of said anchors is configured to engage a support surface thereby inhibiting the vehicle from being floated away by the flood waters, each of said anchors being lifted into said respective anchor actuator when said respective anchor actuator is actuated into a lifting condition.

2. The assembly according to claim 1, wherein said plurality of bladders includes a pair of side bladders, a front bladder and a back bladder, each of said side bladders being positioned adjacent to a respective one of a first lateral side and a second lateral side of the vehicle, said front bladder being aligned with a front side of the vehicle, said back bladder being aligned with a back side of the vehicle, each of said bladders having an inflation port being integrated therein for inflating said bladders.

3. The assembly according to claim 1, wherein:
said assembly includes a control circuit being integrated into the vehicle, said control circuit being electrically coupled to a power source comprising an electrical system of the vehicle, said control circuit receiving an inflate input and a deflate input; and
said pump is electrically coupled to said control circuit, said pump being actuated into said inflating condition when said control circuit receives said inflate input wherein said pump is configured to facilitate the vehicle to be floated on the flood waters, said pump being actuated into said inflating condition for a pre-determined duration of time when said control circuit receives said inflate input such that said pump inflates each of said bladders to a sufficient volume to float the vehicle, said pump being actuated into said deflating condition when said control circuit receives said deflate input wherein said pump is configured to deflate said bladders when the flood waters have subsided.

4. The assembly according to claim 3, wherein said water sensor is electrically coupled to said control circuit, said control circuit receiving said inflate input when said water sensor senses flood waters, said control circuit receiving said deflate input when said water sensor ceases to sense the flood waters subsequent to said water sensor sensing the flood waters.

5. The assembly according to claim 3, wherein each of said anchor actuators is electrically coupled to said control circuit, each of said anchor actuators being actuated into said lowering condition when said control circuit receives said inflate input, each of said anchor actuators being actuated into said lifting condition when said control circuit receives said deflate input, each of said anchor actuators being aligned with a respective one of the first lateral side and the second lateral side of the vehicle.

6. The assembly according to claim 5, further comprising a plurality of cables, each of said cables being in mechanical communication with a respective one of said anchor actuators, each of said cables being lowered downwardly out of said respective anchor actuator when said respective anchor actuator is actuated into said lowering condition, each of said cables being drawn upwardly into said respective anchor actuator when said respective anchor actuator is actuated into said lifting condition.

7. A vehicle flotation assembly for floating a vehicle in flood waters for inhibiting the vehicle from being damaged, said assembly comprising:
a plurality of bladders, each of said bladders being coupled to a bottom side of a vehicle, each of said bladders being inflatable wherein said plurality of bladders is configured to float the vehicle when the vehicle is exposed to flood waters thereby inhibiting the vehicle from being damaged by the flood waters, each of said bladders being distributed around a perimeter of the vehicle wherein said plurality of bladders is configured to float the vehicle on a level plane thereby inhibiting the vehicle from tipping in the flood waters, said plurality of bladders including a pair of side bladders, a front bladder and a back bladder, each of said side bladders being positioned adjacent to a respective one of a first lateral side and a second lateral side of the vehicle, said front bladder being aligned with a front side of the vehicle, said back bladder being aligned with a back side of the vehicle, each of said bladders having an inflation port being integrated therein for inflating said bladders;
a control circuit being integrated into the vehicle, said control circuit being electrically coupled to a power source comprising an electrical system of the vehicle, said control circuit receiving an inflate input and a deflate input;
a water senor being coupled to the vehicle, said water sensor being strategically positioned on the vehicle wherein said water sensor is configured to sense flood waters rising beneath the vehicle, said water sensor being electrically coupled to said control circuit, said control circuit receiving said inflate input when said water sensor senses flood waters, said control circuit receiving said deflate input when said water sensor ceases to sense the flood waters subsequent to said water sensor sensing the flood waters;
a pump being coupled to the vehicle, said pump being in fluid communication with each of said bladders wherein said pump is configured to inflate each of said bladders when said pump is turned on, said pump having in intake and an exhaust wherein said pump is configured to urge inwardly through said intake and outwardly through said exhaust when said pump is actuated into an inflating condition, said pump facilitating air to move outwardly through said intake when said pump is actuated into a deflating condition, said pump being electrically coupled to said control circuit, said pump being actuated into said inflating condition when said control circuit receives said inflate input wherein said pump is configured to facilitate the vehicle to be floated on the flood waters, said pump being actuated into said inflating condition for a pre-determined duration of time when said control circuit receives said inflate input such that said pump inflates each of said bladders to a sufficient volume to float the vehicle, said pump being actuated into said deflating condition when said control circuit receives said deflate input wherein said pump is configured to deflate said bladders when the flood waters have subsided;
an air manifold having an inlet and a plurality of outlets each being in fluid communication with said inlet, said inlet being fluidly coupled to said exhaust of said pump, each of said outlets being fluidly coupled to said inflation port on a respective one of said bladders wherein said air manifold is configured to direct air between said pump and each of said bladders for inflating or deflating said bladders;
a plurality of anchor actuators, each of said anchor actuators being coupled to the bottom side of the vehicle, each of said anchor actuators being electrically coupled to said control circuit, each of said anchor actuators being actuated into a lowering condition when said control circuit receives said inflate input, each of said anchor actuators being actuated into a lifting condition when said control circuit receives said deflate input, each of said anchor actuators being aligned with a respective one of the first lateral side and the second lateral side of the vehicle;
a plurality of cables, each of said cables being in mechanical communication with a respective one of said anchor actuators, each of said cables being lowered downwardly out of said respective anchor actuator when said respective anchor actuator is actuated into said lowering condition, each of said cables being drawn upwardly into said respective anchor actuator when said respective anchor actuator is actuated into said lifting condition; and
a plurality of anchors, each of said anchors being disposed on a respective one of said anchor actuators, each of said anchors being lowered from said respective anchor actuator when said respective anchor actuator is actuated into said lowering condition wherein each of said anchors is configured to engage a support surface thereby inhibiting the vehicle from being floated away by the flood waters, each of said anchors being lifted into said respective anchor actuator when said respective anchor actuator is actuate into said lifting condition, each of said anchors being coupled to a distal end of a respective one of said cables, each of said anchors being comprised of a material having sufficiently density to facilitate each of said anchors to have a weight of at least 10.0 pounds.

8. A vehicle flotation system for floating a vehicle in flood waters for inhibiting the vehicle from being damaged, said system comprising:
a vehicle having a bottom side, a first lateral side, a second lateral side, a front side and a back side;
a plurality of bladders, each of said bladders being coupled to said bottom side of said vehicle, each of said bladders being inflatable wherein said plurality of bladders is configured to float said vehicle when said vehicle is exposed to flood waters thereby inhibiting said vehicle from being damaged by the flood waters, each of said bladders being distributed around a perimeter of said vehicle wherein said plurality of bladders is configured to float said vehicle on a level plane thereby inhibiting said vehicle from tipping in the flood waters, said plurality of bladders including a pair of side bladders, a front bladder and a back bladder, each of said side bladders being positioned adjacent to a respective one of said first lateral side and said second lateral side of the vehicle, said front bladder being aligned with said front side of the vehicle, said back bladder being aligned with said back side of the vehicle, each of said bladders having an inflation port being integrated therein for inflating said bladders;
a control circuit being integrated into the vehicle, said control circuit being electrically coupled to a power source comprising an electrical system of said vehicle, said control circuit receiving an inflate input and a deflate input;
a water senor being coupled to said vehicle, said water sensor being strategically positioned on said vehicle wherein said water sensor is configured to sense flood waters rising beneath said vehicle, said water sensor being electrically coupled to said control circuit, said control circuit receiving said inflate input when said water sensor senses flood waters, said control circuit receiving said deflate input when said water sensor ceases to sense the flood waters subsequent to said water sensor sensing the flood waters;
a pump being coupled to said vehicle, said pump being in fluid communication with each of said bladders wherein said pump is configured to inflate each of said bladders when said pump is turned on, said pump having in intake and an exhaust wherein said pump is configured to urge inwardly through said intake and outwardly through said exhaust when said pump is actuated into an inflating condition, said pump facilitating air to move outwardly through said intake when said pump is actuated into a deflating condition, said pump being electrically coupled to said control circuit, said pump being actuated into said inflating condition when said control circuit receives said inflate input wherein said pump is configured to facilitate said vehicle to be floated on the flood waters, said pump being actuated into said inflating condition for a pre-determined duration of time when said control circuit receives said inflate input such that said pump inflates each of said bladders to a sufficient volume to float said vehicle, said pump being actuated into said deflating condition when said control circuit receives said deflate input wherein said pump is configured to deflate said bladders when the flood waters have subsided;
an air manifold having an inlet and a plurality of outlets each being in fluid communication with said inlet, said inlet being fluidly coupled to said exhaust of said pump, each of said outlets being fluidly coupled to said inflation port on a respective one of said bladders wherein said air manifold is configured to direct air between said pump and each of said bladders for inflating or deflating said bladders;
a plurality of anchor actuators, each of said anchor actuators being coupled to the bottom side of said vehicle, each of said anchor actuators being electrically coupled to said control circuit, each of said anchor actuators being actuated into a lowering condition when said control circuit receives said inflate input, each of said anchor actuators being actuated into a lifting condition when said control circuit receives said deflate input, each of said anchor actuators being aligned with a respective one of the first lateral side and the second lateral side of the vehicle;
a plurality of cables, each of said cables being in mechanical communication with a respective one of said anchor actuators, each of said cables being lowered downwardly out of said respective anchor actuator when said respective anchor actuator is actuated into said lowering condition, each of said cables being drawn upwardly into said respective anchor actuator when said respective anchor actuator is actuated into said lifting condition; and
a plurality of anchors, each of said anchors being disposed on a respective one of said anchor actuators, each of said anchors being lowered from said respective anchor actuator when said respective anchor actuator is actuated into said lowering condition wherein each of said anchors is configured to engage a support surface thereby inhibiting the vehicle from being floated away by the flood waters, each of said anchors being lifted into said respective anchor actuator when said respective anchor actuator is actuate into said lifting condition, each of said anchors being coupled to a distal end of a respective one of said cables, each of said anchors being comprised of a material having sufficiently density to facilitate each of said anchors to have a weight of at least 10.0 pounds.
